(19) United States
(12) Patent Application Publication
(10) Pub. No.: US 2023/0093085 A1
(43) Pub. Date: Mar. 23, 2023

(54) STOW AND TOW DRAY CART

(71) Applicant: AMIR DJERASSI, SR., Tel Aviv (IL)

(72) Inventor: AMIR DJERASSI, SR., Tel Aviv (IL)

(21) Appl. No.: 17/795,558

(22) PCT Filed: Feb. 3, 2021
(86) PCT No.: PCT/IL2021/050124

§ 371 Date: Jul. 27, 2022

Related U.S. Application Data
(60) Provisional application No. 62/969,690, filed on Feb. 4, 2020.

(51) Int. Cl. B62B 1/00; B62B 1/20; B62B 3/02; B62B 5/00

(52) U.S. Cl. CPC B62B 1/002; B62B 1/206; B62B 1/208; B62B 3/02; B62B 5/0043; B62B 2202/403; B62B 2205/04; B62B 2205/104

(57) ABSTRACT

A dray cart comprising: a foldable load frame on which a load to be moved may be supported, the load frame having protruding mounting pegs and through holes; and a wheel dolly to which wheels are mountable and formed having mounting slots for receiving the mounting pegs so that the wheel dolly may be assembled to and disassembled from the load frame.

### RELATED APPLICATIONS

The present application claims the benefit under 35 U.S.C. 119(e) of U.S. Provisional Application 62/969,690 filed on Feb. 4, 2020 the disclosure of which is incorporated herein by reference.

### FIELD

Embodiments of the application relate to a cart for moving loads that may be folded into a compact state for storage or transportation in a relatively small space.

### BACKGROUND

Various tasks may be well served by a multipurpose dray cart that can be comfortably configured for storage in relatively small spaces and reconfigured for manual operation to receive and move a load that is typically difficult for a single person to manhandle. For example, such a multipurpose dray cart might comfortably be stowed in a truck or car and used to offload goods from the truck or from a car trailer hauled by the car to deliver the goods to a final destination.

### SUMMARY

An aspect of an embodiment of the disclosure relates to providing a stowable, multipurpose dray cart having a storage configuration in which the cart occupies a relatively small volume and an “operational” configuration in which the cart is configured to be operated to receive and move a load. In an embodiment the cart, hereinafter also referred to as a STOW&TOW cart, or simply a STOW&TOW, comprises a foldable load frame on which a load to be moved may be supported, and at least one wheel dolly detachably mounted to the load frame so that the frame and a load supported by the frame may be wheeled to a desired location. In an embodiment, the foldable load frame comprises portions referred to as half frames which in the operational configuration are substantially linear extensions of each other and in the storage configuration are jackknife folded together for storage. The dolly wheel is readily detached from the foldable load frame and the load frame jackknife folded from the operational configuration to the storage configuration for storage. The load frame may be unfolded from the storage configuration, locked to the operational configuration suitable for supporting a load, and mounted with the wheel dolly for convenient moving of the load. The load frame optionally comprises mounting pegs and the wheel dolly formed having matching mounting slots for receiving the mounting pegs. The wheel dolly may be quickly assembled to and disassembled from the load frame by sliding the load frame mounting pegs respectively into and out from the wheel dolly mounting slots and securing or releasing the dolly from the load frame by a detent bolt.

In a storage configuration of STOW&TOW, in accordance with an embodiment of the disclosure, the wheel dolly is disassembled from the load frame and the load frame jackknifed to the storage configuration of the frame. In the storage configuration, STOW-&-TOW is, optionally, sized to fit into a passenger sedan.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

FIG. 1 schematically shows a STOW&TOW comprising a wheel dolly mounted to a load frame, in accordance with an embodiment of the disclosure;

FIG. 2A schematically shows the STOW&TOW load frame after disassembly from the wheel dolly, in accordance with an embodiment of the disclosure;

FIG. 2B schematically shows the STOW&TOW wheel dolly after disassembly from the load frame, in accordance with an embodiment of the disclosure;

FIG. 2C schematically shows the STOW&TOW load frame jackknife folded to a storage configuration, in accordance with an embodiment of the disclosure;

FIG. 3A schematically shows the load frame after folding as shown in FIG. 2C, loaded into the passenger side of a sedan, in accordance with an embodiment of the disclosure;

FIG. 3B schematically shows the STOW&TOW shown in FIG. 1 stored in the boot of a sedan after the STOW&TOW load frame is jackknife folded into a storage configuration without disassembly from the wheel dolly, in accordance with an embodiment of the disclosure;

FIGS. 4A and 4B schematically show perspective views of a motorized wheel dolly configured to be mounted to the load frame shown in FIGS. 1 and 2A, in accordance with an embodiment of the disclosure;

FIG. 4C schematically shows the motorized wheel dolly shown in FIGS. 4A and 4B with a cowling removed to show internal parts of the wheel dolly, in accordance with an embodiment of the disclosure;

FIG. 5A schematically shows a person loading a jet-ski from a car trailer onto a STOW&TOW, in accordance with an embodiment of the disclosure;

FIG. 5B schematically shows the person shown in FIG. 5A moving the jet-ski and STOW&TOW along a sandy terrain, in accordance with an embodiment of the disclosure; and

FIG. 6 schematically shows a 4 wheeled motorized STOW&TOW, in accordance with an embodiment of the disclosure;

FIG. 7A schematically shows a holding bracket that may be mounted to a tow bar of, optionally, a jet ski trailer and configured to hold a STOW&TOW mounted on the tow bar. in accordance with an embodiment of the disclosure;

FIG. 7B schematically shows the holding bracket shown in FIG. 7A holding the STOW&TOW shown in FIGS. 5A and 5B mounted on the tow bar shown in FIG. 7A, in accordance with an embodiment of the disclosure; and

FIG. 8 schematically shows the STOW&TOW shown in FIGS. 5A and 5B disassembled and packaged as a do-it yourself kit, in accordance with an embodiment of the disclosure.

### DETAILED DESCRIPTION

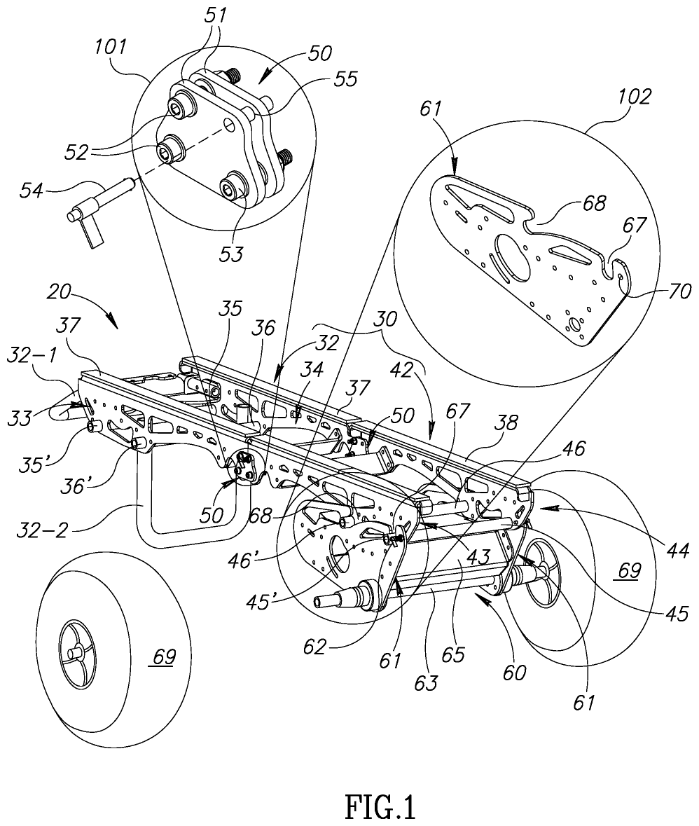

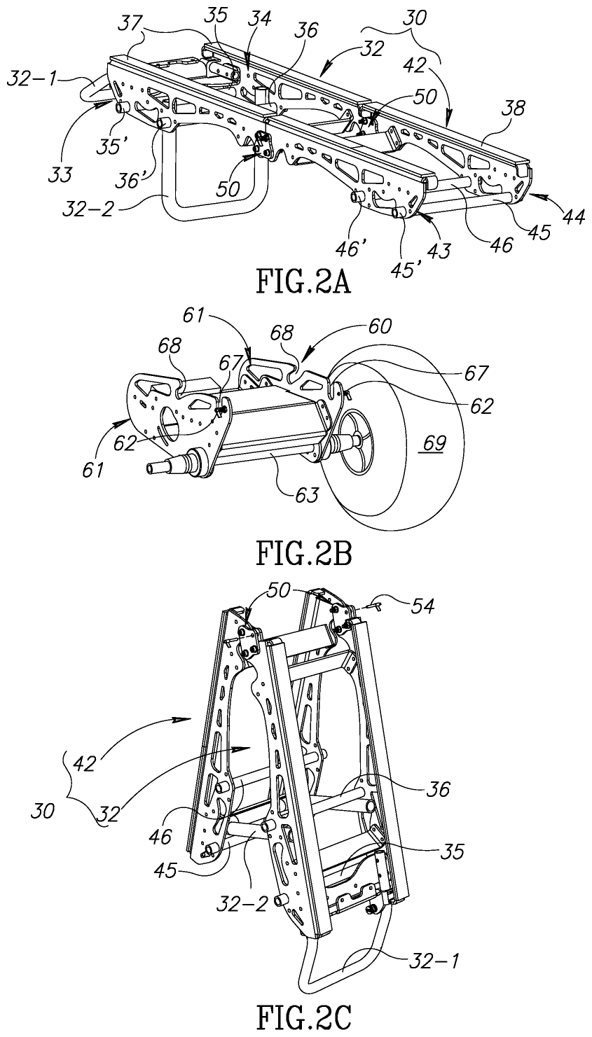

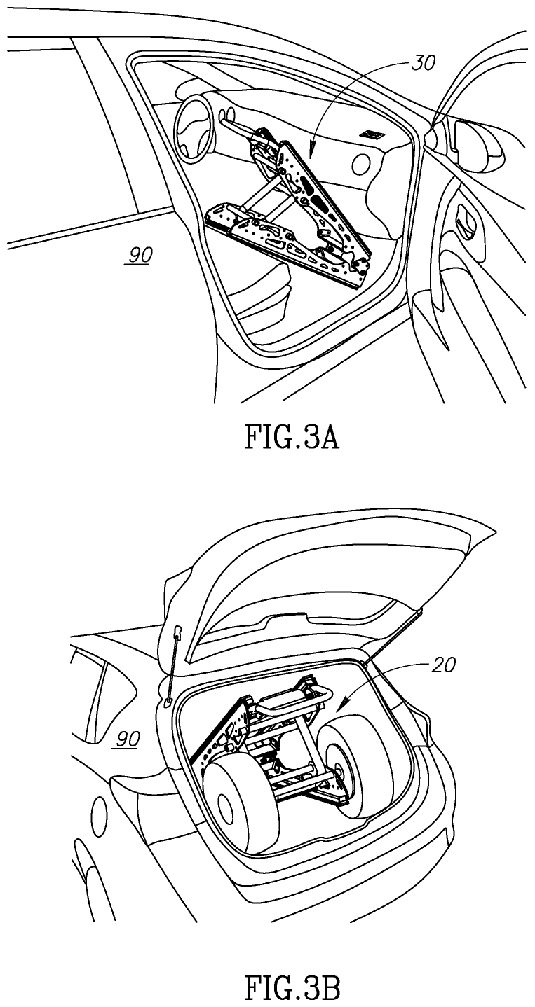

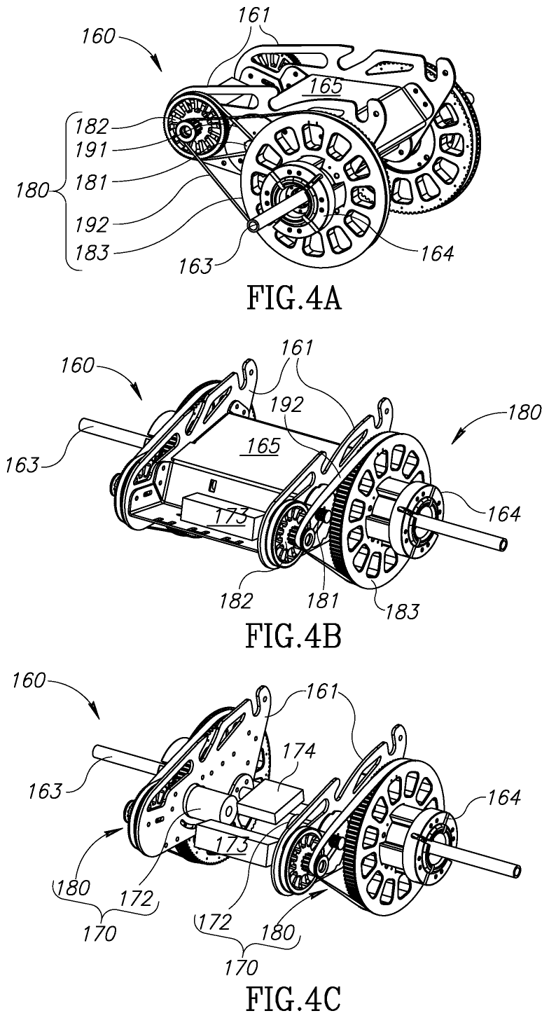

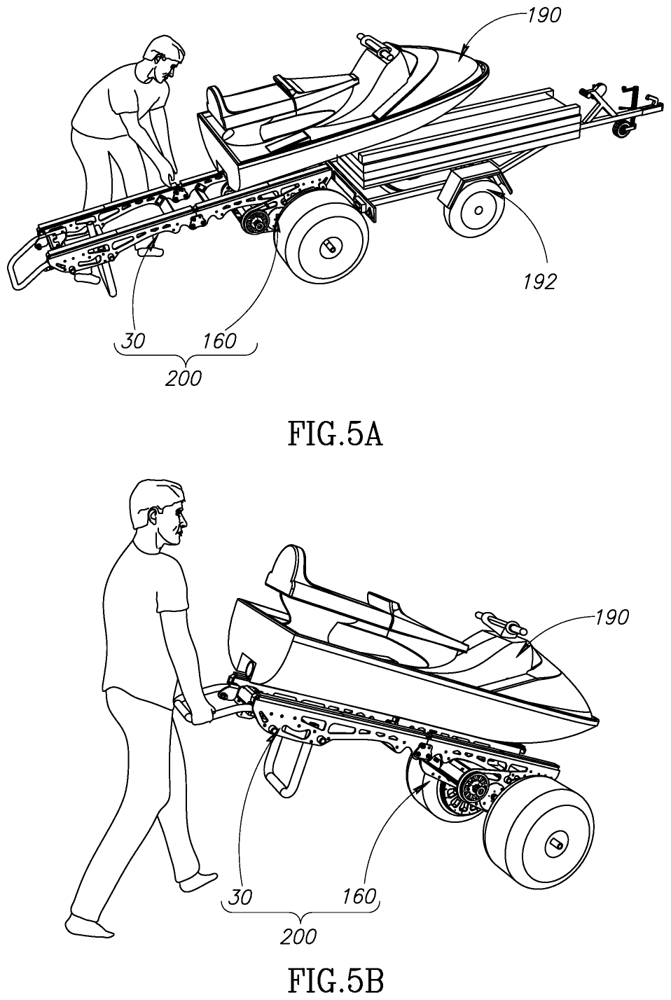

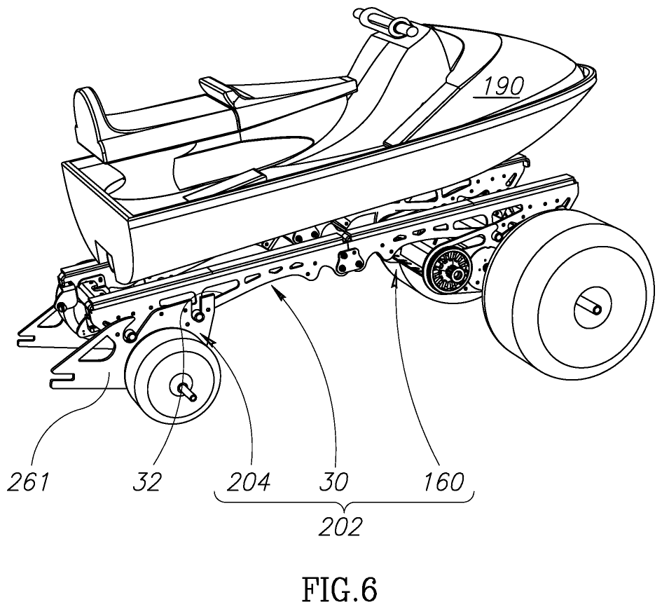

In the following detailed discussion a STOW&TOW and components of the STOW&TOW in accordance with an embodiment of the disclosure are discussed with reference to FIGS. 1 and FIGS. 2A-2C. FIG. 1 schematically shows a STOW&TOW in an operational configuration in which the STOW&TOW is operable to receive and transport a load. Disassembling the STOW&TOW wheel dolly from the STOW&TOW load frame is discussed with reference to FIGS. 2A and 2B, which respectively show the load frame and wheel dolly of the STOW&TOW shown in FIG. 1 separately, after disassembly from each other. Jackknife folding of the STOW&TOW load frame is discussed with reference to FIG. 2C. Stowing a STOW&TOW in a sedan is discussed with reference to FIGS. 3A and 3B. Motorized version of a STOW&TOW wheel dolly are shown and discussed with reference to FIGS. 4A-4C. FIGS. 5A and 5B show using a STOW&TOW to move a jet-ski to a beach. FIG. 6 shows a motorized, four-wheel STOW&TOW.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. Unless otherwise indicated, the word “or” in the description and claims is considered to be the inclusive “or” rather than the exclusive or, and indicates at least one of, or any combination of more than one of items it conjoins.

FIG. 1 schematically shows a STOW&TOW 20 in an operational configuration comprising a load frame 30 and a detachable wheel dolly 60 mounted to the load frame, in accordance with an embodiment of the disclosure. Wheel dolly 60 includes, optionally two, wheels 69 to facilitate manually moving the STOW&TOW and a load that a user might load onto load frame 30.

Load frame 30 comprises two, optionally mirror image half frames 32 and 42 which in the operational configuration are substantially linear extensions of each other as shown in FIGS. 1 and 2A. Half frame 32 comprises optionally two mirror image support rails 33 and 34 connected by an optionally tubular outer coupling tie 35 and an optionally tubular inner coupling tie 36. Coupling ties 35 and 36 extend beyond support rails 33 and 34 to provide protuberances referred to as mounting pegs 35′ and 36′ respectively. It is noted that whereas half frame 32 has four mounting pegs—two extending beyond each of rails 33 and 34, only those mounting pegs 35′ and 36′ on the side of STOW&TOW 20 from which wheel 69 is displaced are shown. Optionally, rails 33 and 34 are respectively mounted with load runners 37 formed from a resilient material that operate to prevent damage to a load supported by the rails. Similarly, half frame 42 comprises optionally two mirror image load support rails 43 and 44 connected by an optionally tubular outer coupling tie 45 and an optionally tubular inner coupling tie 46. Coupling ties 45 and 46 extend beyond support rails 43 and 44 to provide mounting pegs 45′ and 46′ respectively. Optionally, rails 43 and 44 are mounted respectively with load runners 47 similar to load runners 37. Half frame 42 is optionally mounted with wheel dolly 60, and half frame 32 is optionally fitted with a grip handle 32-1 for manually grasping and moving STOW&TOW 20 and an underprop 32-2 on which half frame 32 rests when STOW&TOW 20 grip handle 32-1 is not held by a user.

Half frames 32 and 42 are connected by optionally two flange clamps 50, one of which couples rail 33 of half frame 32 to rail 43 of half frame 42, and another of which couples rail 34 of half frame 32 to rail 44 of half frame 42. An enlarged image of a flange clamp 50 is schematically shown in an inset 101. Flange clamp 50 optionally comprises two mirror flanges 51, two clamping bolts 52 for fixedly clamping the flange clamp to a rail of one of half frames 32 and 42, a rotation bolt 53 that enables a rail of the other of half frames 32 and 42 to be rotatably held between the flanges; and a detent pin, such as by way of example a quick release locking safety pin, 54 for locking in place the rotatably held rail when load frame 30 is in the operational configuration.

In an embodiment, a flange clamp 50 is fixed to each rail 33 and 34 of half frame 32 by clamping bolts 52 to sandwich and clamp the rail between flange plates 51 of the flange clamp. Rotation bolts 53 rotatably connect rails 43 and 44 to flange clamps 50 that are fixed to rails 33 and 34 respectively by clamping bolts 52. When in the operational configuration, clearance holes (not shown) formed in rails 43 and 44 align with clearance holes 55 formed in flanges 50 of flange clamps 50 and detent pins 54 may be inserted through the clearance holes to lock rails 43 and 44 to rails 33 and 34 respectively and thereby half frame 32 to half frame 42 in the operational configuration of load frame 30 shown in FIG. 1.

Wheel dolly 60 may comprise two optionally mirror image support panels 61, one of which is shown enlarged in an inset 102, that support an axle 63 to which wheels 69 are mounted. Support panels 61 are coupled together optionally by a cowling 65 and are formed having mounting slots 67 and 68 and a clearance hole 70 for mounting and securing wheel dolly 60 to load frame 30. Mounting slots 67 and 68 are matched to mounting pegs 45′ and 46′ respectively, wheel dolly 60 is mounted to load frame 30 as shown in FIG. 1 by seating mounting peg 46′ in slot 68, rotating wheel dolly 60 counterclockwise as seen from mounting peg 46′ shown in the figure until mounting peg 45′ seats in mounting slot 67 and securing panels 61 in place with, optionally, indexing plungers 62 that are mounted to support panels 61 and may be operated to secure the support panels to half frame 32.

STOW&TOW 20 as schematically shown FIG. 1 is disassembled by operating indexing plungers 62 to extract their respective plunger pins from wheel dolly 60 and load frame 30, rotating the wheel dolly about mounting peg 46′ to unseat mounting peg 45′ from slot 67 and translating the wheel dolly to free the wheel dolly from mounting peg 68. Load frame 30 after disassembly from wheel dolly 60 is shown in FIG. 2A and the wheel dolly is shown in FIG. 2B. Load frame 30 may be jackknife folded to the storage configuration schematically shown in FIG. 2C by removing detent pins 54 shown in FIG. 1 and FIG. 2A from the load frame and rotating half frame 42 about rotation bolt 53 to fold half frame 42 towards half frame 32.

In an embodiment STOW&TOW 20 is dimensioned so that load frame 30 in the storage configuration shown in FIG. 2C may be comfortably loaded into a sedan 90, optionally in the front seat passenger side of the sedan as schematically shown in FIG. 3A. Whereas in FIG. 3A load frame 30 is shown folded after wheel dolly 60 has been disassembled from the load frame, the load frame may be jackknife folded without being disassembled from wheel dolly 60. FIG. 3B schematically shows wheel dolly 60 assembled to load frame 30, and the load frame jackknife folded into the storage configuration and STOW&TOW 20 loaded into the boot of sedan 90.

FIGS. 1-2C show a STOW&TOW 20 that is manually operated, however a STOW&TOW in accordance with an embodiment of the disclosure may comprise a motorized wheel dolly to assist a person operating a STOW&TOW.

FIGS. 4A and 4B schematically show different perspective views of a motorized wheel dolly 160 suitable for mounting to load frame 30 to provide a motorized STOW&TOW in accordance with an embodiment of the disclosure. Wheel dolly 160 optionally comprises two support panels 161 that support a wheel axle 163 having wheel mounts 164 to which wheels (not shown in FIGS. 4A-4C) of the wheel dolly may be attached, and a cowling 165 that connects support panels 161 to each other and covers and protects components of wheel dolly 160. FIG. 4C schematically shows the motorized wheel dolly shown in FIGS. 4A and 4B with cowling 165 removed to show features of the motorized dolly that the cowling protects.

As schematically shown in FIGS. 4A-4C, wheel dolly 160 optionally comprises a wheel drive system 170 (FIG. 4C) mounted to each support panel 161 that is operable to rotate a wheel mounted to a wheel mount 164 supported by axle 163. Each drive system 170 optionally comprises an electric motor 172 (FIG. 4C) that receives power for driving wheel the wheel mount 164 from an optionally common battery 173 (FIGS. 4B, 4C), and a transmission system 180 that transmits power from the electric motor to wheel mount 164 and thereby a wheel mounted to the wheel mount. In an embodiment the electric motor 172 is an electric skateboard motor, such as may be marketed in an electric skateboard motor kit. Transmission system 180 is optionally a timing belt and pulley transmission comprising a drive pulley 181 coupled by inner and outer timing belts 191 and 192 respectively and a compound pulley 182 to an output pulley 183 mounted to wheel axle 163. Electric motor 172 is coupled to and rotates drive pulley 181 to rotate output pulley 183 and thereby wheel mount 164. A controller 174 coupled by wire or wirelessly to electric motors 172 controls each drive system 170. In an embodiment controller 174 may be operated to control drive systems 170 and rotation of wheel mounts 164 and wheels mounted to the wheel mounts optionally by a hand operated switch and/or throttle (not shown) generically referred to as a throttle, located in grip handle 32-1 of load carriage (FIGS. 1 and 2A) 30. A user operating a STOW&TOW 20 motorized by wheel dolly 160 to move a load mounted to the STOW&TOW, may operate the throttle to control the wheel dolly and assist the user in moving the load.

FIGS. 5A and 5B schematically show a user respectively moving a jet ski 190 from a car trailer 192 onto an optionally motorized STOW&TOW 200 comprising a motorized wheel dolly 160 and load frame 30, and pushing, with the assistance of traction provided by the motorized dolly, the STOW&TOW loaded with the jet ski on a sandy beach area, in accordance with an embodiment of the disclosure.

FIGS. 1-5B schematically show embodiments of STOW&TOWs that are manually operated using grip handle 32-1 (FIG. 1, FIG. 2A) and that having only two wheels. However, a STOW&TOW in accordance with an embodiment of the disclosure is not limited to having only two wheels or to being operated manually. A STOW&TOW in accordance with an embodiment of the disclosure may have for example three or four wheels, of which a wheel or wheels additional to wheels shown in FIGS. 1-5B may be mounted to half frame 32 and replace underprop 32-2. And a STOW&TOW comprising motorized wheel dolly 160 may be controlled wirelessly by controlling the wheel dolly via wireless communication, using a smart communication device such as a joystick, smartphone, phablet, tablet, laptop and a suitable wireless interface such as by way of example, Bluetooth, WiFi, LiFi, and/or 5G.

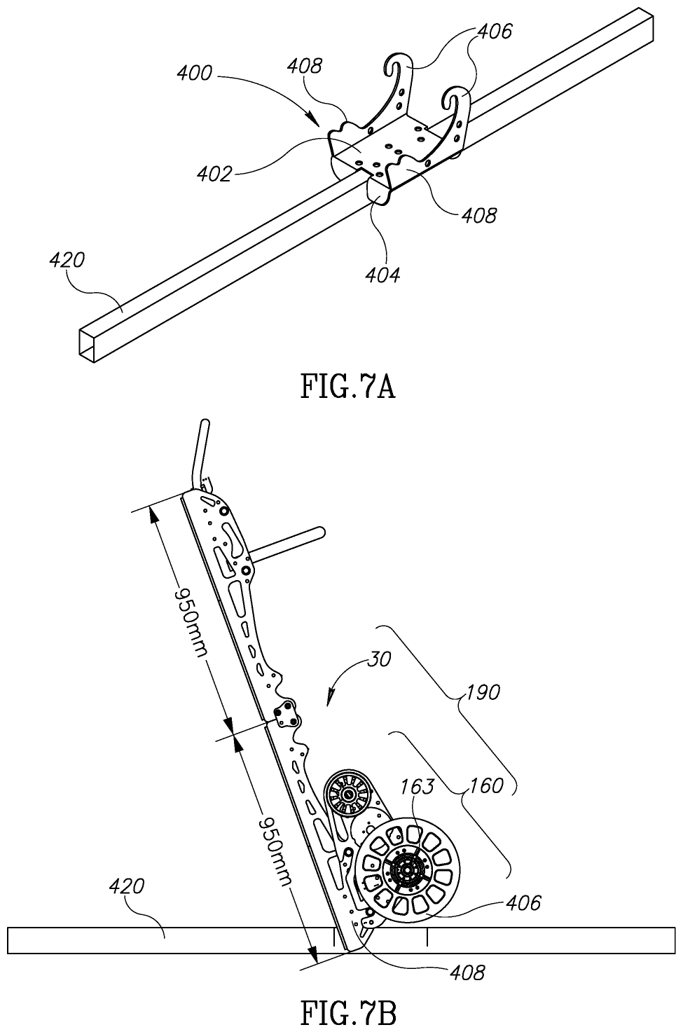

FIG. 6 schematically shows a STOW&TOW 4-WHEELER 202 optionally comprising load frame 30, mounted with wheel dolly 160 and a wheel carriage 204, being controlled by wirelessly controlling the wheel dolly to move by way of example jet-ski 190. Wheel carriage 204 optionally comprises support panels 261 similar to support panels 61 (FIGS. 1-2C) and 161 (FIGS. 4A-4C), and is mounted to half frame 32 similarly to the manner in which motorized wheel dolly 160 is mounted to half frame 42 (not shown in FIG. 6).

Whereas STOW&TOWs 20 and 190 may be dimensioned so that it fits into the passenger space of a sedan or the boot of a sedan, a fully assembled STOW&TOW may be mounted and secured to a tow bar of, optionally, a jet ski trailer by a holding bracket, in accordance with an embodiment of the disclosure. A holding bracket 400 configured to hold an assembled STOW&TOW, in accordance with an embodiment of the disclosure is schematically shown mounted to a tow bar 420 of a jet ski trailer (not shown) in FIGS. 7A and 7B. Holding bracket 400 comprises a bottom plate 402 having optionally four aligning tongues 404 (only two of which are shown in FIG. 7A) that aid in aligning the holding bracket to tow bar 420, and, optionally two, axle clasps 406, and two braces 408. Axle clasps 406 are configured to hook onto axle 163 (FIGS. 4A-4C) of wheel dolly 60 of STOW&TOW 190 and braces 408 are configured to contact cowling 165 (FIGS. 4A, 4B) and support STOW&TOW at a fixed attitude when axle clasps 406 are hooked onto axle 163 and STOW&TOW is held by holding bracket 400. Holding bracket 400 may be mounted to tow bar 420 by bolting bottom plate 402 to the tow bar. FIG. 7B schematically shows a side view of STOW&TOW 190 mounted and secured to tow bar 420 by holding bracket 400. Axle clasps 406 that hook onto axle 163 and braces 408 that contact cowling 165 (not shown in FIG. 7B), which would not normally be seen from the perspective of FIG. 7B are shown in silhouette.

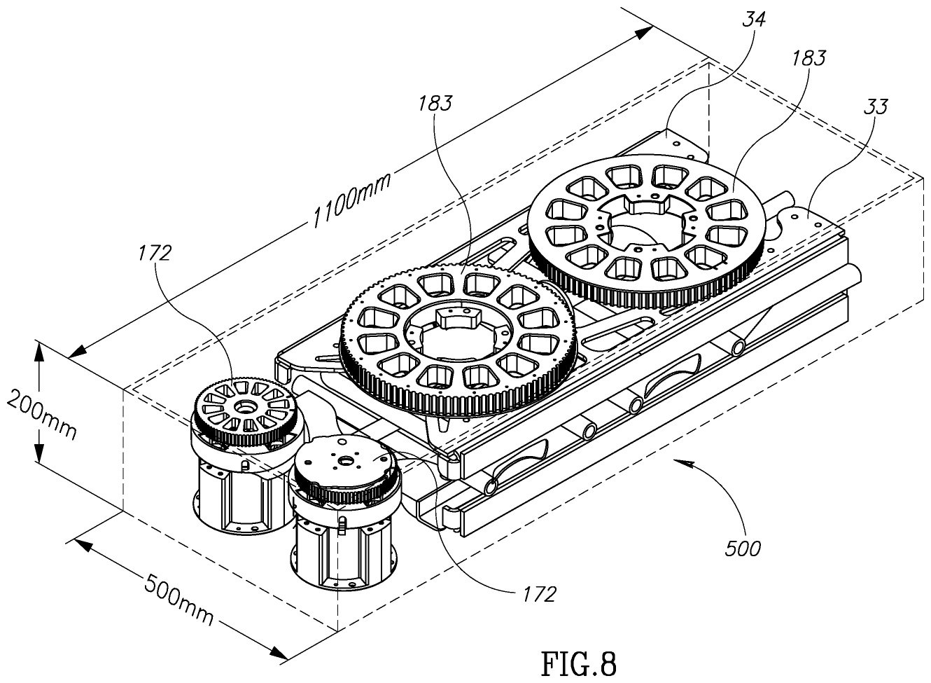

In an embodiment a STOW&TOW in accordance with an embodiment of the disclosure, such as STOW&TOW 190 may be packaged disassembled in a relatively light weight relatively small package for do it yourself assembly that may be carried by a single person. By way of example, FIG. 8 schematically shows STOW&TOW 190 disassembled and packaged in a do-it yourself package 500. Package 500 includes all the components of STOW&TOW 190 with the exception of wheels 69 (FIG. 1). The package has dimensions shown in FIG. 8: about 1,100 mm long; about 500 mm wide; and about 200 mm high. The total weight of the contents may be equal to about 24 Kg. Various components of disassembled STOW&TOW 190 visible in FIG. 8 are labeled with the labels shown for the components in FIGS. 1-4C.

There is therefore provided in accordance with an embodiment of the disclosure a dray cart comprising: a foldable load frame on which a load to be moved may be supported, the load frame having protruding mounting pegs and through holes; and a wheel dolly to which wheels are mountable and formed having mounting slots for receiving the mounting pegs so that the wheel dolly may be assembled to and disassembled from the load frame. Optionally, the mounting slots are configured having open ends through which the pegs are slidable into and out from the slots for assembly and disassembly of the wheel dolly to and from the load frame. Alternatively or additionally, the wheel dolly and load frame may be formed having matching holes for receiving a pin or bolt to secure the wheel dolly to the load frame. Optionally, the wheel cart comprises an index plunger for insertion into the matching hole formed in the load frame to secure the wheel dolly to the load frame.

In an embodiment the load frame comprises two half frames are connected by flange clamps fixed to one of the half frames to which flange clamps the other half frame is rotatably coupled to enable the half frames to be jackknife folded toward each other from an operational configuration in which the two half frames are linear extensions of each other. Optionally, the rotatably coupled half fame and the clamps are formed having matching through holes through which a pin may be inserted to lock the two half frames in the operational configuration.

In an embodiment the wheel dolly comprises at least one axle to which the wheels are mountable and at least one motor operable to generate torque that rotates the wheels. Optionally, the at least one motor comprises a different motor for each wheel. Optionally the dray cart comprises a throttle operable to control a motor of at least one motor. Optionally, the throttle comprises a smart communication device operable to control the at least one motor wirelessly.

In an embodiment the dray cart is dimensioned so that the load frame when jackknife folded may be stored in a region of the passenger compartment of an automobile sedan. Optionally, the region of the passenger compartment is a region between the front seat and the sedan dashboard. In an embodiment the dray cart is dimensioned so that the dray cart when having the wheel dolly mounted to the load frame and the load frame jackknife folded may be stored in a boot of an automotive sedan. In an embodiment the dray cart is dimensioned so that when disassembled all the parts of the dray cart with the exception of wheels may be stored in a rectangular box that may be manually carried by a single person. Optionally, the rectangular box is less than or about 1,200 mm long; less than or about 550 mm wide; and less than or about 220 mm high. Alternatively or additionally, the parts stored in the box may have a combined total weight of about 24 kg.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

1. A dray cart comprising:
a foldable load frame on which a load to be moved may be supported, the load frame having protruding mounting pegs and through holes; and
a wheel dolly to which wheels are mountable and formed having mounting slots for receiving the mounting pegs so that the wheel dolly may be assembled to and disassembled from the load frame.

2. The dray cart according to claim 1 wherein the mounting slots are configured having open ends through which the pegs are slidable into and out from the slots for assembly and disassembly of the wheel dolly to and from the load frame.

3. The dray cart according to claim 1 wherein the wheel dolly and load frame are formed having matching holes for receiving a pin or bolt to secure the wheel dolly to the load frame.

4. The dray cart according to claim 3 wherein the wheel cart comprises an index plunger for insertion into the matching hole formed in the load frame to secure the wheel dolly to the load frame.

5. The dray cart according to claim 1 wherein the load frame comprises two half frames are connected by flange clamps fixed to one of the half frames to which flange clamps the other half frame is rotatably coupled to enable the half frames to be jackknife folded toward each other from an operational configuration in which the two half frames are linear extensions of each other.

6. The dray cart according to claim 5 wherein the rotatably coupled half fame and the clamps are formed having matching through holes through which a pin may be inserted to lock the two half frames in the operational configuration.

7. The dray cart according to claim 1 wherein the wheel dolly comprises at least one axle to which the wheels are mountable and at least one motor operable to generate torque that rotates the wheels.

8. The dray cart according to claim 7 wherein the at least one motor comprises a different motor for each wheel.

9. The dray cart according to claim 8 and comprising a throttle operable to control a motor of at least one motor.

10. The dray cart according to claim 9 wherein the throttle comprises a smart communication device operable to control the at least one motor wirelessly.

11. The dray cart according to claim 1 and dimensioned so that the load frame when jackknife folded may be stored in a region of the passenger compartment of an automobile sedan.

12. The dray cart according to claim 11 wherein the region of the passenger compartment is a region between the front seat and the sedan dashboard.

13. The dray cart according to claim 1 and dimensioned so that the dray cart when having the wheel dolly mounted to the load frame and the load frame jackknife folded may be stored in a boot of an automotive sedan.

14. The dray cart according to claim 1 and dimensioned so that when disassembled all the parts of the dray cart with the exception of wheels may be stored in a rectangular box that may be manually carried by a single person.

15. The dray cart according to claim 14 wherein the rectangular box is less than or about 1,200 mm long; less than or about 550 mm wide; and less than or about 220 mm high.

16. The dray cart according to claim 14 wherein the parts stored in the box have a combined total weight of about 24 kg.
